(19) United States
(12) Patent Application Publication
(10) Pub. No.: US 2010/0095370 A1
(43) Pub. Date: Apr. 15, 2010

(54) SELECTIVE PACKET CAPTURING METHOD AND APPARATUS USING KERNEL PROBE

(75) Inventors: Byung Joon LEE, Daejeon (KR); Seong MOON, Daejeon (KR); You Hyeon JEONG, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/535,154

(22) Filed: Aug. 4, 2009

(30) Foreign Application Priority Data
Oct. 9, 2008 (KR) 10-2008-0099299

(51) Int. Cl. G06F 11/30; H04L 9/32; H04L 29/06

(52) U.S. Cl. 726/13; 713/164

(57) ABSTRACT

The present invention discloses a packet capturing method using a kernel probe, which is for capturing traffic generated only by a specific application. The packet capturing method using a kernel probe comprises the steps of: acquiring the 5-tuple information of a packet associated with the application to capture by intercepting a specific set of operating system networking kernel functions using a kernel probe which intercepts calls to the functions; capturing packets inputted and outputted through a network device; and identifying traffic generated by the application by comparing the 5-tuple information with 5-tuple information of the captured packets.

### CROSS-REFERENCE TO RELATED APPLICATION

This application claims the benefit of Korean Application No. 10-2008-0099299 filed on Oct. 9, 2008 in the Korean Intellectual Property Office, the disclosure of which is incorporated by reference.

### BACKGROUND OF THE INVENTION

1. Field of the Invention

The present invention relates to a selective packet capturing method and apparatus using a kernel probe, and more particularly, to a selective packet capturing method and apparatus using a kernel probe, which can accurately identify traffic generated by a specific application.

The present invention is derived from research performed as a part of IT next generation engine core technology development work by the Ministry of Information and Communication and the Institute for Information Technology Advancement. [Research No.: 2006-S-010-01, Research Title: Multi-layer Optical Network Control Platform Technology Development]

2. Discussion of the Related Art

File sharing programs such as P2P increase network traffic.

Some file sharing programs allow each terminal participating in file sharing to function as a server, as well as allowing a terminal to download a file from a specific server.

A file sharing program allows each terminal to acquire a file from other terminals. In addition, the file sharing program provides information of file fragments that a terminal has to a plurality of other terminals so that the file is shared, and the other terminals frequently inquire for the file fragments that the terminal has. Thus, the terminal of each individual using a sharing program generates much traffic, and makes the network congested.

Accordingly, there is a growing demand for a network management solution for identifying traffic generated by a specific application, such as a file sharing program (e.g., a file sharing program, which will be omitted hereinafter), and limiting the traffic of terminals.

For the purpose, inspection methods such as payload inspection or communication pattern analysis have been used traditionally to identify traffic generated by a specific Internet application in the middle of Internet.

The payload inspection method is a method of inspecting the byte pattern of the payload of packets, and the communication behavior pattern inspection method is a method of checking a communication pattern in which packets are exchanged between end hosts.

In the payload inspection method, byte patterns (representative signatures) are used for inspection. Only the packets which have a matching byte pattern to the signatures are identified as being generated by a specific Internet application.

In the communication behavior pattern inspection method, behavioral patterns are used for inspection. Only the packets which are exchanged by following a known set of communication patterns are identified as being generated by a specific internet application.

Therefore, it is important to find correct representative signatures or communication patterns for the success of payload or communication behavior pattern inspection method. It requires a lot of offline reverse engineering on a complete traffic trace for which it is guaranteed that every packet within the trace is generated by a specific Internet application.

Currently, there is no tool or technology which aids the creation of the complete traffic trace generated by a specific Internet application.

### SUMMARY OF THE INVENTION

This object, according to the present invention, is achieved by a packet capturing method using a kernel probe, comprising the steps of: acquiring the 5-tuple information of a packet associated with an internet application to capture by intercepting a specific set of operating system networking kernel functions using a kernel probe which intercepts calls to the functions; capturing a packet inputted and outputted through a network device; and deciding if the captured packet is generated by the application by comparing the 5-tuple information of the captured packet with the 5-tuple information created by the kernel probe.

This object, according to the present invention, is achieved by a packet capturing apparatus using a kernel probe, which acquires application name and 5-tuple information through a kernel probe intercepting calls to operating system networking kernel functions, comprising: a kernel module for acquiring 5-tuple information of a packet associated with the application through the kernel probe; and a packet capturing module for identifying traffic generated by the application by comparing 5-tuple information of a packet transmitted and received through a network device with the 5-tuple information provided by the kernel module.

The present invention can classify and capture traffic generated only by a specific application.

Further, it is possible to easily extract a representative signature or behavioral pattern used in an immersion detection system using the traffic captured by carrying out the present invention.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a conceptual diagram of a packet capturing method using a kernel probe according to the present invention;

FIG. 2 is a conceptual block diagram of one example of a packet capturing apparatus using a kernel probe according to the present invention;

FIG. 3 shows a flow chart of the capturing method using kernel module; and

FIG. 4 shows a flow chart of the selective packet capturing method packet capturing module according to the present invention

### DETAILED DESCRIPTION OF THE PREFERRED EMBODIMENTS

Advantages and features of the present invention and a method of achieving the advantages and the features will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art and the present invention is defined only by the appended claims. Like reference numerals designate like elements throughout the detailed description.

Hereinafter, the present invention will be described in detail with reference to the drawings.

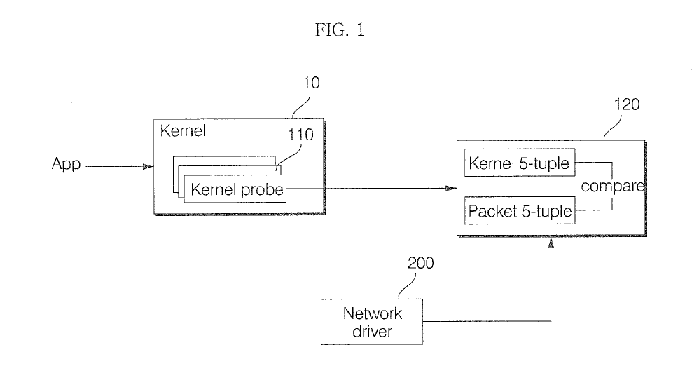

FIG. 1 is a conceptual diagram of a packet capturing method using a kernel probe (hereinafter, referred to as a packet capturing method) according to the present invention.

In the present invention, a kernel probe 110 is inserted into a kernel 10 of an operating system installed in a terminal. When a specific network function (e.g., in case of a UNIX base operating system, inet_sendmsg( ), sock_common_recvmsg( ), etc.) is called, the kernel probe 110 analyzes parameters passed to the function and extracts the name of the application associated with the call and extracts 5-tuple information of the packet to be processed by the call. The extracted information is passed to the capturing module 120 if the extracted name coincides with the name of the application to be captured.

The 5-tuple information is information about the sender IP, recipient IP, sender port number, recipient port number, and protocol of packets transmitted to or received from an application.

The capturing module 120 stores the 5-tuple information given by the kernel probe 110. The capturing module 120 is able to decide whether the captured packets are packets generated by a specific application or not by comparing the 5-tuple information of the packets captured through the network driver 200 with the 5-tuple information provided by the kernel probe 110.

Accordingly, a packet capture method of the present invention is implemented by a kernel probe 110 inserted into the kernel 10 of the operating system and a capturing module 120 for selectively capturing packets by using the 5-tuple information captured by the kernel probe 110 at the outside of the kernel 10.

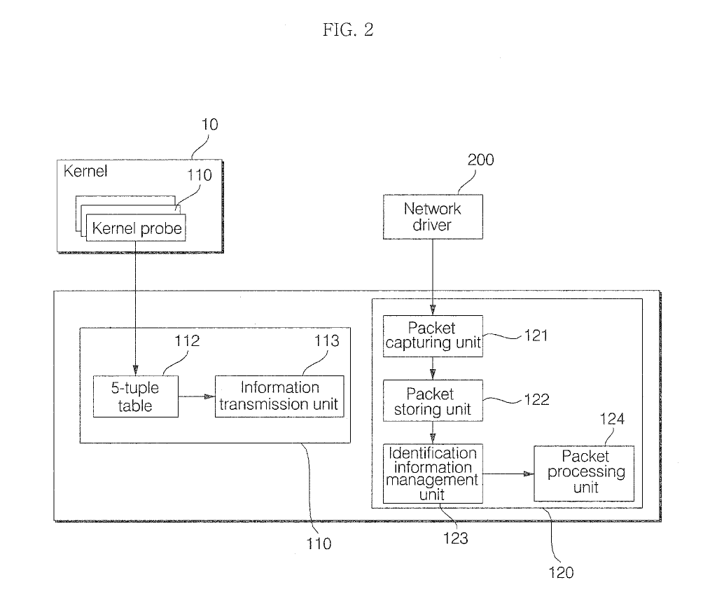

FIG. 2 is a conceptual block diagram of one example of a packet capturing apparatus using a kernel probe according to the present invention.

The illustrated packet capturing apparatus using a kernel probe (hereinafter, referred to as a packet capturing apparatus) includes a kernel module 110 and a packet capturing module 120.

The kernel module 110 impregnates the kernel probe 111 in the kernel 10, and intercepts calls to the network functions of the kernel 10 through the kernel probe 111. The network functions into which the probe is inserted are functions that are necessarily called when an application sends or receives packets. The probe analyzes information delivered to corresponding functions when the corresponding functions are called and extract the name of the application associated with the call and 5-tuple information of packets processed by the call. If the name of the application is consistent with the application name to capture, the extracted 5-tuple information is stored in a 5-tuple table 112. Whenever a new 5-tuple is stored in the 5-tuple table 112, an information transmission unit 113 assembles information thereof in packets and transmits them to the packet capturing module 120.

The packet capturing module 120 captures packets sent and received by a network driver 200, extracts 5-tuple information from the captured packets, and then compares it with 5-tuple information provided by the kernel module 110.

As a result of comparison, if the 5-tuple information of packets captured through the network driver 200 is identical to the 5-tuple information provided by the kernel module 110, the packet capturing module 120 recognizes the packets as being packets generated by an application which is a target of packet capturing, and stores information on the corresponding packets in the form of a file.

Preferably, the packet capturing module 120 includes a packet capturing unit 121, a packet storing unit 122, an identification information management unit 123, and a packet processing unit 124.

The packet capturing module 121 stores packets sent and received through the network driver 200.

The packet capturing module 122 buffers the packets provided by the packet capturing module 121 for a predetermined time, and then provides them to the packet processing unit 124. Preferably, the packet storing unit 122 follows a queue storage method on a first in first out basis. The queue storage method is useful in sequentially storing packets and sequentially providing them to the packet processing unit 123 because packets are outputted in a receiving order.

The identification information management unit 123 is provided with the 5-tuple information provided by the information transmission unit 113.

The packet processing unit 124 extracts 5-tuple information from the packets provided by the packet storing unit 122, and compares the extracted 5-tuple information with the 5-tuple information stored in the identification information management unit 123. As a result of comparison, if there are packets having the 5-tuple information stored in the identification information management unit 123, the corresponding packets are stored in the form of a file.

Meanwhile, the file created by the packet processing unit 124 may be useful in generating a traffic identification pattern used in the payload inspection method and the communication behavior pattern inspection method. The reliability of the traffic identification pattern is the highest when it is extracted from the packets that are evidently generated from an application to be identified. The file created in the packet processing unit 124 may be used to generate a traffic identification pattern having a high reliability since it is assured that the file is created by capturing packets generated only by a specific application.

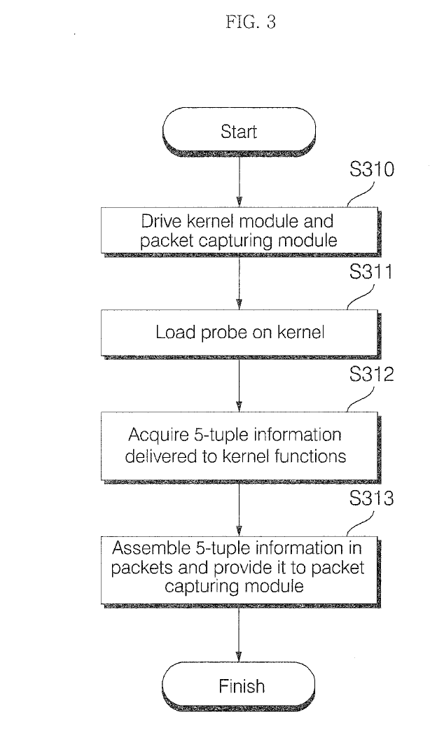

FIG. 3 shows a flow chart of the capturing method using kernel module.

First, the packet capturing apparatus comprising the kernel module and the packet capturing module 120 is driven in response to a command from an administrator (S310).

When the packet capturing apparatus is driven, the kernel module loads the kernel probe 111 to the kernel of the operating system (S311). When specific network functions within the kernel 10 are called in order to process transmitted and received packets, the kernel probe analyzes information delivered to the functions and extracts 5-tuple information of the transmitted and received packets (S312). Next, the kernel module 110 assembles the extracted 5-tuple information in packets, and provides them to the packet capturing module (S313).

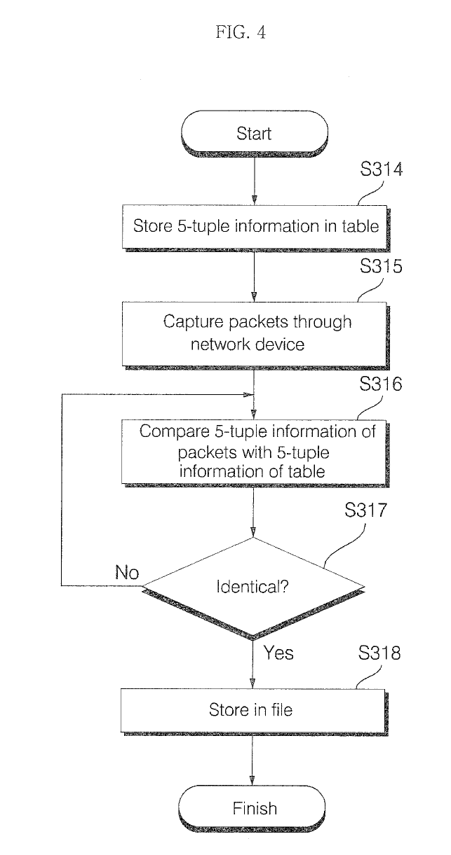

FIG. 4 shows a flow chart of the selective packet capturing method packet capturing module according to the present invention

First, The packet capturing module 120 stores the 5-tuple information in the form of packets provided by the kernel module 110 in the identification information management unit 123 (S314), and the identification information management unit 123 buffers it for a predetermined time, and then applies it to the packet processing unit 124.

Next, the packet capturing unit 121 acquires packets entering and leaving a network driver installed in an operating system, and stores them in the packet storage unit 122 (S315). The packets stored in the packet storing unit 122 are buffered for a predetermined time, and then applied to the packet processing unit 124. The packet processing unit 122 analyzes the packets provided from the packet storing unit 122 and extracts 5-tuple information contained in the packets. The packet processing unit 124 compares the 5-tuple information of the extracted packets with the 5-tuple information stored in the identification information management unit 123 (S316). As a result of comparison, if both of them are identical to each other (S317), the packets whose 5-tuple information is identical to that stored in the identification information management unit 123 are stored in a file (S31S), and if not identical, the step S316 is repeated.

While the embodiment of the invention has been described with reference to the figures, it will be evident to those skilled in the art that the present invention may be embodied in other specific forms without departing from the spirit or essential characteristics thereof. The present embodiments are therefore to be considered in all respects as illustrative and not restrictive.

What is claimed is:

1. A selective packet capturing method using a kernel probe, comprising the steps of:
acquiring the 5-tuple information of a packet associated with an internet application to capture by intercepting a specific set of operating system networking kernel functions using a kernel probe which intercepts calls to the functions;
capturing packets input and output through a network device; and
identifying traffic generated by the application by comparing the 5-tuple information of the captured packets and the 5-tuple information extracted by the kernel probe.

2. The selective packet capturing method of claim 1, wherein the 5-tuple information is information about any one of the sender IP, recipient IP, sender port number, recipient port number, and protocol of the packets.

3. The selective packet capturing method of claim 1, wherein the step of capturing packets inputted and outputted through a network device is the step of capturing packets through a driver for the network device.

4. The selective packet capturing method of claim 1, wherein the step of identifying traffic comprises the steps of:
storing the 5-tuple information in a first storage medium;
sequentially storing the 5-tuple information of the packets in a second storage medium; and
identifying traffic caused by the application by comparing the 5-tuple information stored respectively in the first and second storage mediums with each other.

5. The selective packet capturing method of claim 4, wherein the step of identifying traffic further comprises the step of recording the traffic generated by the application in a file.

6. A packet capturing apparatus using a kernel probe, which acquires 5-tuple information through a kernel probe intercepting the 5-tuple information transmitted to network functions of a kernel, comprising:
a kernel module for acquiring 5-tuple information of packets transmitted or received by an application program using the kernel probe; and
a packet capturing module for identifying traffic generated by the application by comparing 5-tuple information of a packet transmitted and received through a network device with the 5-tuple information provided by the kernel module.

7. The packet capturing apparatus of claim 6, wherein the kernel probe intercepts the 5-tuple information provided in the kernel functions by the application when the application calls the network functions of the kernel.

8. The packet capturing apparatus of claim 6, wherein the 5-tuple information is information about any one of the sender IP, recipient IP, sender port number, recipient port number, and protocol of the packets.

9. The packet capturing apparatus of claim 6, wherein the packet capturing module comprises:
a packet capturing unit for capturing packets sent and received through a driver of the network device;
an identification information management unit for storing the 5-tuple information provided by the kernel module; and
a packet processing unit for identifying traffic generated by the application by comparing the 5-tuple information provided in the identification information management unit with 5-tuple information extracted in the packet storing unit.

10. The packet capturing apparatus of claim 9, wherein the packet processing unit stores, in the form of a file, packet information of the packets whose 5-tuple information is identical to the 5-tuple information stored in the identification information management unit.
